(19) United States
(12) Patent Application Publication
(10) Pub. No.: US 2026/0170788 A1
(43) Pub. Date: Jun. 18, 2026

(54) ELECTRONIC DEVICE

(71) Applicant: CANON KABUSHIKI KAISHA, Tokyo (JP)

(72) Inventor: Ken YANAGIBASHI, Kanagawa (JP)

(21) Appl. No.: 19/420,958

(22) Filed: Dec. 16, 2025

(30) Foreign Application Priority Data
Dec. 17, 2024 (JP) 2024-220488

(51) Int. Cl. G06V 10/25; G06T 5/50

(52) U.S. Cl. CPC G06V 10/25; G06T 5/50; G06T 2207/20221

(57) ABSTRACT

An electronic device acquires an image, sets a crop area of the image and is an area extracted from the image, sets a graphic area of the image on which a graphic is to be superimposed, and performs control to display the image in a mode indicating the crop area and the graphic area, wherein, the graphic area is settable in association with the crop area, and in a case where the graphic area is associated with the crop area, if a setting of the crop area is changed, a display of the graphic area is changed so that a relative position and a relative size of the graphic area with respect to the crop area are maintained, but even if a setting of the graphic area is changed, a display of the crop area is not changed.

### BACKGROUND

### Field of the Technology

The present disclosure relates to an electronic device and more particularly to a technique for displaying an image so as to illustrate an area.

### Description of the Related Art

A marker function that assists shooting by displaying a marker frame as a guide of a safety zone or an on-screen text insertion position at the time of video distribution in a part of a video area at the time of shooting has been suggested. In the marker function, the user can adjust the marker frame so as to indicate a desired area by changing the position and size of the marker frame.

In addition, a crop function of setting a part of a video area as a crop area and recording and outputting the entire video area (hereinafter, referred to as an entire video) and a video of the crop area (hereinafter, referred to as a crop video) has also been suggested. In the crop function, the user can adjust the angle of view of the crop video by changing the position and size of the crop area. Further, by displaying a crop frame indicating the crop area in a manner of being superimposed on the entire video, the user can simultaneously confirm the entire video and the crop video.

Japanese Patent Laid-Open No. 2015-84926 discloses a processing device that moves a plurality of displayed crop frames having different sizes in conjunction with each other and confirms a crop frame to be output from among the crop frames.

However, the marker frame is not automatically adjusted so that the user can adjust the marker frame according to the movement of the imaging target. At the time of shooting the crop video distribution, a marker frame as a guide of a safety zone or an on-screen text insertion position of the crop video may be displayed. In this case, the adjustment frequency of the marker frame is high, and the load on the user is large in many cases.

### SUMMARY

The present disclosure provides a technique capable of reducing an adjustment frequency of a marker frame (an area on which graphics are superimposed).

An electronic device according to the present disclosure includes a processor, and a memory storing a program which, when executed by the processor, causes the electronic device to execute an acquisition process of acquiring an image, execute a first setting process of setting a crop area that is a part of an area of the image and is an area extracted from the image, execute a second setting process of setting a graphic area that is a part of an area of the image and is an area on which a graphic is to be superimposed, and execute a control process of performing control to display the image in a mode indicating the crop area and the graphic area, wherein, in the second setting process, the graphic area is settable in association with the crop area, and in a case where the graphic area is associated with the crop area, in the control process, if a setting of the crop area is changed, a display of the graphic area is changed so that a relative position and a relative size of the graphic area with respect to the crop area are maintained, but even if a setting of the graphic area is changed, a display of the crop area is not changed.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram of a camera according to a first embodiment.

FIG. 2A is a schematic diagram of setting items and setting values of a crop area.

FIG. 2B is a schematic diagram of setting items and setting values in a marker area.

FIG. 3 is a schematic diagram of a crop area setting screen.

FIGS. 4A to 4C are schematic diagrams of a marker area position setting screen.

FIG. 5 is a flowchart of processing of the camera at the time of setting the marker area position.

FIG. 6 is a schematic diagram of a correspondence relationship between a marker reference and a settable range.

FIG. 7 is a flowchart of processing of the camera when a shooting screen is displayed.

FIGS. 8A to 8E are schematic diagrams of a shooting screen.

FIG. 9 is a schematic diagram of the crop area setting screen.

FIG. 10 is a block diagram of a camera according to a second embodiment.

FIGS. 11A to 11E are schematic diagrams of an output video.

FIG. 12 is a schematic diagram of setting items and setting values for externally outputting a video.

FIG. 13 is a flowchart of processing of the camera at the time of external output of the video.

### DESCRIPTION OF THE EMBODIMENTS

### First Embodiment

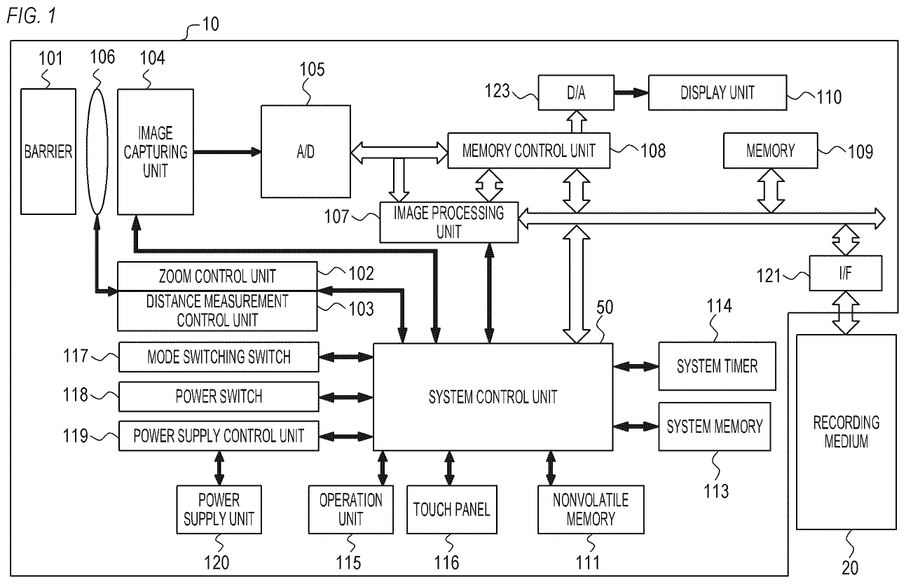

A first embodiment of the present disclosure is described. FIG. 1 is a block diagram illustrating a configuration of a digital video camera (camera) 10 as an example of an electronic device to which the present disclosure can be applied.

A shooting lens 106 is a lens group that includes a zoom lens and a focus lens. The zoom lens is a lens for changing a zoom magnification by changing a focal length. The zoom lens is controlled by a zoom control unit 102. The focus lens is a lens for performing focusing. The focus lens is controlled by a distance measurement control unit 103.

An image capturing unit 104 is an image capturing element (image sensor) configured with a CCD, a CMOS element, or the like that converts an optical image into an electrical signal. An A/D converter 105 converts an analog signal output from the image capturing unit 104 into a digital signal. A barrier 101 covers an image capturing system (a portion including the shooting lens 106 and the like) of the camera 10 to prevent contamination and damage of the image capturing system.

An image processing unit 107 performs predetermined image processing (for example, a resizing process such as pixel interpolation and reduction, or a color conversion process) on image data from the A/D converter 105 or image data from a memory control unit 108. The image processing unit 107 performs a predetermined calculation process using captured image data, and a system control unit 50 performs exposure control and distance measurement control based on the calculation result obtained by the image processing unit 107. Accordingly, an autofocus (AF) process, an auto exposure (AE) process, and a flash preliminary emission (EF) process of a through the lens (TTL) method are performed.

The image data from the A/D converter 105 is written on a memory 109 via the image processing unit 107 and the memory control unit 108 or via the memory control unit 108. In the memory 109, for example, image data that is obtained by the image capturing unit 104 and converted into digital data by the A/D converter 105 is stored for various processes. The memory 109 has a storage capacity sufficient to store a predetermined number of still images, a moving image for a predetermined period of time, and a sound. The memory 109 also serves as a memory (video memory) for image display, and image data to be displayed on a display unit 110 is also stored in the memory 109. The display unit 110 displays, for example, image data that is obtained by the image capturing unit 104 and converted into digital data by the A/D converter 105, image data that is read from a recording medium 122, and the like. On Screen Display (OSD) data may be displayed on the display unit 110.

A D/A converter 123 converts the image data for display that is stored in the memory 109 into an analog signal and supplies the converted analog signal to the display unit 110. Accordingly, the image data for display that is written on the memory 109 is displayed by the display unit 110 via the D/A converter 123. The display unit 110 is a display such as a liquid crystal display (LCD) and performs display in accordance with an analog signal from the D/A converter 123. The digital signal that is A/D converted by the A/D converter 105 and accumulated in the memory 109 is converted into an analog signal by the D/A converter 123 to be sequentially transferred to the display unit 110 and displayed. Accordingly, a live view image is displayed, and a function as an electronic viewfinder is realized. The display unit 110 may be an organic electroluminescence (EL) display or the like. The size of the display unit 110 is not particularly limited and may be, for example, a small liquid crystal monitor having a display surface size of 3.5 inches. The display unit 110 may be an external monitor connected to the camera 10 using an external output terminal such as a high definition multimedia interface (HDMI) or a serial digital interface (SDI).

A nonvolatile memory 111 is an electrically erasable/recordable memory and is, for example, an EEPROM. In the nonvolatile memory 111, constants, programs, and the like for an operation of the system control unit 50 are stored. The program is a program executing various flowcharts described below.

The system control unit 50 controls the entire camera 10. The system control unit 50 realizes each process described below by executing the program stored in the nonvolatile memory 111. The system control unit 50 also performs display control by controlling the memory 109, the D/A converter 123, the display unit 110, and the like.

A system memory 113 is, for example, a RAM. In the system memory 113, for example, constants, variables, and programs read from the nonvolatile memory 111 for the operation of the system control unit 50 are stored. A system timer 114 is a timer unit that counts time used for various controls and time of an embedded clock.

An operation unit 115 is used to input various operation instructions (various instructions from the user) to the system control unit 50. The system control unit 50 performs various processes in response to instructions input from the user via the operation unit 115. The operation unit 115 includes various buttons such as a menu button, a cancellation button, four-direction keys (up, down, left, and right keys), a SET key, and an AF/MF key. For example, when the menu button is pressed, a menu screen on which various settings can be made is displayed on the display unit 110. The user can intuitively perform various settings by using the menu screen displayed on the display unit 110, together with four-direction keys and a SET key.

A touch panel 116 is a touch sensor that detects various touch operations on a display surface of the display unit 110 (an operation surface of the touch panel 116). The touch panel 116 and the display unit 110 can be integrated. For example, the touch panel 116 is configured so that transmittance of light does not disturb displaying of the display unit 110 and is attached to an upper layer of the display surface of the display unit 110. Then, input coordinates on the touch panel 116 are associated with display coordinates on the display surface of the display unit 110. Accordingly, it is possible to provide a graphical user interface (GUI) as if the user can directly operate the screen displayed on the display unit 110.

A mode switching switch 117 switches the operation mode of the system control unit 50 to one of a moving image recording mode, a reproduction mode, and the like.

A power switch 118 is a push button for switching on and off the power of the camera 10.

A power supply control unit 119 is configured with a battery detection circuit, a DC-DC converter, a switch circuit that switches a block to be energized, and the like and detects whether a battery is mounted, the type of battery, a remaining battery level, and the like. The power supply control unit 119 controls the DC-DC converter based on a detection result and an instruction of the system control unit 50 and supplies a necessary voltage to each unit including the recording medium 122 for a necessary period. A power supply unit 120 is a primary battery such as an alkaline battery or a lithium battery, a secondary battery such as a NiCd battery, a NiMH battery, or a Li battery, or an AC adapter.

A recording medium I/F 121 is an interface to the recording medium 122 such as a memory card or a hard disk. A recording medium 20 is a recording medium for recording captured image data and includes a semiconductor memory and a magnetic disk.

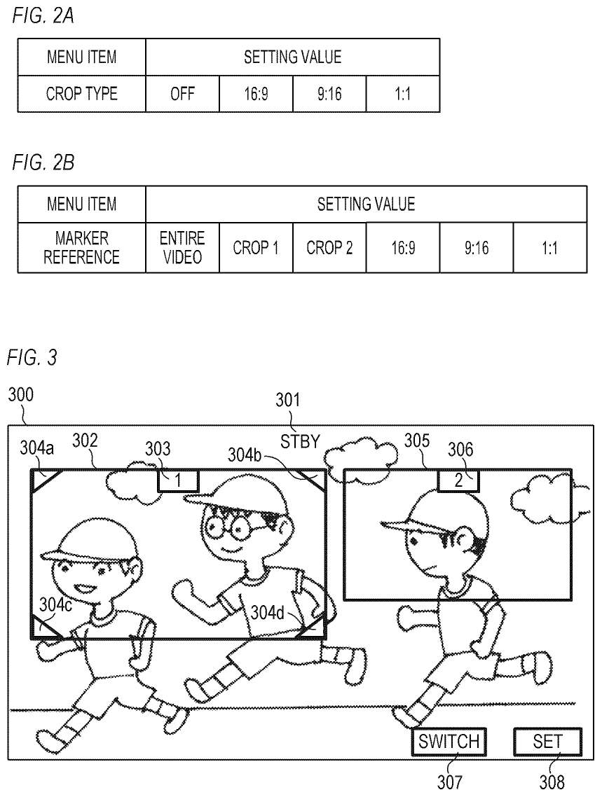

In the first embodiment, the system control unit 50 sets a part of a captured image (video) as a crop area that is an area extracted from the image according to a user's operation on the operation unit 115 or the touch panel 116. FIG. 2A is a schematic diagram illustrating an example of a menu item (setting item) for setting a crop area and a setting value thereof. FIG. 3 is a schematic diagram of a crop area setting screen. When the user selects the item of the crop area setting from the menu screen, the system control unit 50 displays the crop area setting screen of FIG. 3 on the display unit 110.

On the crop area setting screen in FIG. 3, a captured entire video 300 (video of the entire area) is displayed, and a plurality of OSDs are superimposed on the entire video 300. The plurality of OSDs include a recording state 301, a crop 1 frame 302, a crop 1 number 303, crop frame size adjustment cursors 304a to 304d, a crop 2 frame 305, a crop 2 number 306, a switch button 307, and a SET button 308. The recording state 301 indicates whether a video is being recorded. In FIG. 3, the recording state 301 is “STBY” indicating that the video recording is not performed.

The number of crop areas that can be set is not particularly limited but in the first embodiment, two crop areas (the crop 1 and the crop 2) can be set. The crop 1 frame 302 is a frame indicating an area of crop 1, and the crop 2 frame 305 is a frame indicating an area of the crop 2.

As illustrated in FIG. 2A, when setting the crop area, the user selects (designates) “off”, “16:9”, “9:16”, or “1:1” as the crop type using the operation unit 115. When “off” is selected, the crop area is not set. When “16:9” is selected, a crop area having an aspect ratio of 16:9 is set. When a crop video having an aspect ratio of 16:9 (a video of a crop area) is recorded, for example, the system control unit 50 records the crop video having an aspect ratio of 16:9 on the recording medium 20 at a resolution of 1920×1080. When “9:16” is selected, a crop area having an aspect ratio of 9:16 is set. When a crop video having an aspect ratio of 9:16 is recorded, for example, the system control unit 50 rotates the crop video having an aspect ratio of 9:16 by 90 degrees and records the crop video on the recording medium 20 at a resolution of 1920×1080. When “1:1” is selected, a crop area having an aspect ratio of 1:1 is set. In a case where the crop video having an aspect ratio of 1:1 is recorded, for example, the system control unit 50 adds black areas to the left and right of the crop video having the aspect ratio of 1:1 and records the crop video to which the black areas are added on the recording medium 20 at a resolution of 1920×1080.

Note that the recording of the crop video may be performed in parallel (simultaneously) in conjunction with the recording of the entire video, only the crop video may be recorded, or a plurality of crop videos respectively corresponding to a plurality of crop areas may be recorded in parallel (simultaneously). Further, the user may freely designate the aspect ratio of the crop area without selecting the aspect ratio from a plurality of predetermined aspect ratios.

The crop 1 number 303 is associated with the crop 1 frame 302 and indicates that an area in the crop 1 frame 302 is an area of the crop 1. The crop 2 number 306 is associated with the crop 2 frame 305 and indicates that an area in the crop 2 frame 305 is an area of the crop 2. The switch button 307 is a button for switching the crop area to be operated and can be pressed by a touch operation on the touch panel 116. Whenever the switch button 307 is touched, the operation target is switched between the crop 1 (the crop 1 frame 302) and the crop 2 (the crop 2 frame 305). The crop frame size adjustment cursors 304a to 304d are cursors for adjusting the size of the crop area to be operated and are displayed at four corners of the crop area to be operated. In FIG. 3, the crop 1 (the crop 1 frame 302) is an operation target, and the crop frame size adjustment cursors 304a to 304d are displayed at four corners of the crop 1 frame 302. When the user touches and drags (moves the touch position) any one of the crop frame size adjustment cursors 304a to 304d, the size of the crop area to be operated is changed while the aspect ratio of the crop area to be operated is maintained. When the user touches an area other than the crop frame size adjustment cursors 304a to 304d, the switch button 307, and the SET button 308, the position of the crop area to be operated is changed so that the center of the crop area to be operated coincides with the touch position. The SET button 308 is a button for completing (ending) the setting of the crop area. When the SET button 308 is touched, the crop area setting screen is closed (non-display).

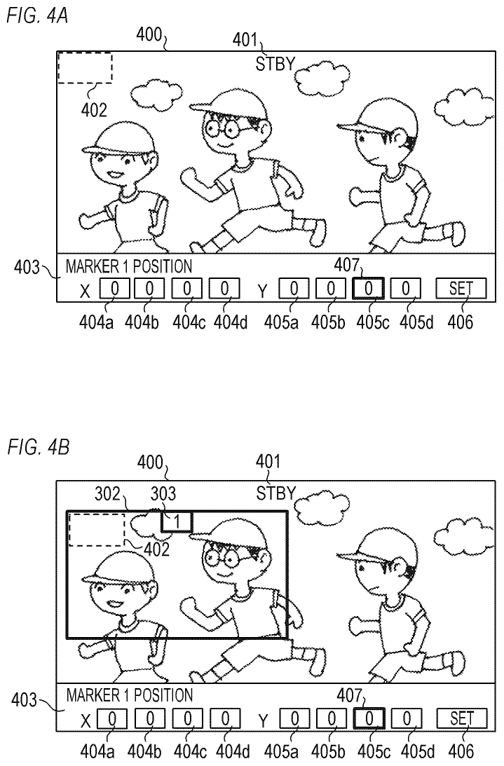

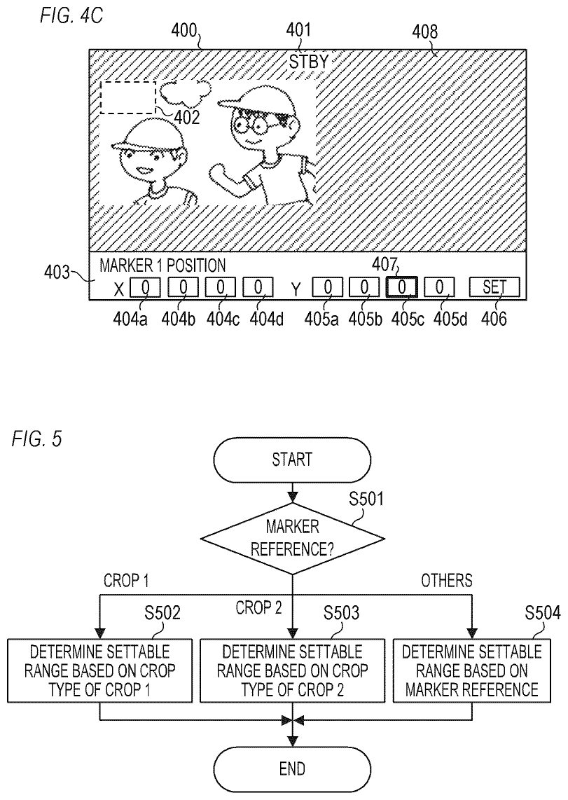

In the first embodiment, the system control unit 50 sets a part of the captured image (video) as a graphic area (marker area) which is an area on which graphics are to be superimposed according to a user's operation on the operation unit 115 or the touch panel 116. FIG. 2B is a schematic diagram illustrating an example of a menu item (setting item) for setting the marker area and a setting value thereof. FIG. 4A is a schematic diagram illustrating an example of a marker area position setting screen. When the user selects the item for setting the marker area position from the menu screen, the system control unit 50 displays the marker area position setting screen of FIG. 4A on the display unit 110.

The number of marker areas that can be set is not particularly limited, but in the first embodiment, it is assumed that two marker areas (a marker 1 and a marker 2) can be set. FIG. 4A illustrates a marker area position setting screen of the marker 1. In the marker area position setting screen of FIG. 4A, the captured entire video 400 is displayed, and the plurality of OSDs are superimposed on the entire video 400. The plurality of OSDs include a recording state 401, a marker frame 402, and a marker area position setting menu 403. The marker frame 402 is a frame indicating a marker area.

In the marker area position setting menu 403, X coordinate buttons 404a to 404d, Y coordinate buttons 405a to 405d, a set button 406, and a cursor 407 are displayed.

The X coordinate button 404a indicates a value of the fourth digit of the X coordinate of the marker area, and the X coordinate button 404b indicates a value of the third digit of the X coordinate of the marker area. The X coordinate button 404c indicates a value of the second digit of the X coordinate of the marker area, and the X coordinate button 404d indicates a value of the first digit of the X coordinate of the marker area. The Y coordinate button 405a indicates a value of the fourth digit of the Y coordinate of the marker area, and the Y coordinate button 405b indicates a value of the third digit of the Y coordinate of the marker area. The Y coordinate button 405c indicates a value of the second digit of the Y coordinate of the marker area, and the Y coordinate button 405d indicates a value of the first digit of the Y coordinate of the marker area.

The cursor 407 indicates a button to be operated. The cursor 407 moves in response to pressing of a left key, a right key, a SET key, or the like of the operation unit 115. For example, when the cursor 407 is at the position of the Y coordinate button 405c, the cursor 407 moves to the position of the Y coordinate button 405b in response to the pressing of the left key and moves to the position of the Y coordinate button 405d in response to the pressing of the right key or the SET key. The present disclosure is not limited to this, and the cursor 407 may move in response to a touch operation on the touch panel 116.

When the cursor 407 indicates one of the X coordinate buttons 404a to 404d and the Y coordinate buttons 405a to 405d, the coordinates of the marker area are changed in accordance with the pressing of the up key or the down key of the operation unit 115. For example, when the cursor 407 indicates the Y coordinate button 405c, the value of the second digit in the Y coordinate is counted up in response to the pressing of the up key, and the value of the second digit in the Y coordinate is counted down in response to the pressing of the down key. When the cursor 407 indicates the set button 406, the X coordinate and the Y coordinate of the marker area are confirmed in response to the press of the SET key, and the marker area position setting screen is closed (non-display). The coordinates of the marker area set on the marker area position setting screen are, for example, coordinates of the center of the marker area. The coordinates of the vertex of the marker area may be set on the marker area position setting screen.

Note that the movement of the cursor 407, the change of coordinates, the confirmation of the coordinates, and the like may be performed according to a touch operation on the touch panel 116.

FIG. 5 is a flowchart illustrating a processing example of the camera 10 when the marker area position setting screen of the marker 1 is displayed. The process in FIG. 5 is implemented by the system control unit 50 loading a program stored in the nonvolatile memory 111 into the system memory 113 and executing the program. For example, when the user selects an item for setting the marker area position from the menu screen, the system control unit 50 starts the process of FIG. 5. Then, the system control unit 50 displays the marker area position setting screen on the display unit 110 based on the result of the process in FIG. 5.

As illustrated in FIG. 2B, when the marker area is set, the user uses operation unit 115 to select (designate) the “entire video”, the “crop 1”, the “crop 2”, “16:9”, “9:16”, or “1:1” as the marker reference. The marker reference “crop 1” can be selected when the crop type of the crop 1 is not “off”, and the marker reference “crop 2” can be selected when the crop type of the crop 2 is not “off”. The marker reference “16:9” can be selected when at least one of the crop type of the crop 1 and the crop type of the crop 2 is “16:9”. The marker reference “9:16” can be selected when at least one of the crop type of the crop 1 and the crop type of the crop 2 is “9:16”. The marker reference “1:1” can be selected when at least one of the crop type of the crop 1 and the crop type of the crop 2 is “1:1”. The marker reference “entire video” can always be selected.

In S501, the system control unit 50 determines whether the marker reference of the marker 1 is the “crop 1”, the “crop 2”, or other than the “crop 1” and the “crop 2”. When the marker reference is the “crop 1”, the process proceeds to S502. When the marker reference is the “crop 2”, the process proceeds to S503. When the marker reference is neither the “crop 1” nor the “crop 2”, the process proceeds to S504.

In S502, the system control unit 50 determines the settable range of the marker area based on the crop type of the crop 1.

In S503, the system control unit 50 determines the settable range of the marker area based on the crop type of the crop 2.

In S504, the system control unit 50 determines the settable range of the marker area based on the marker reference.

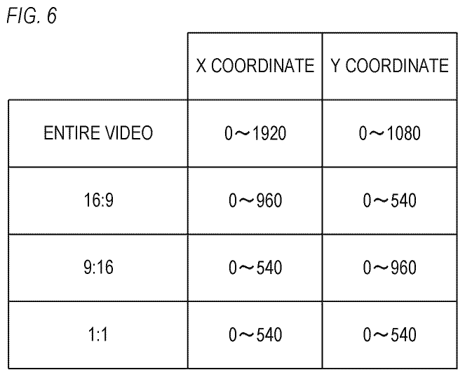

FIG. 6 is a schematic diagram illustrating an example of a correspondence relationship between the marker reference and the settable range. The marker references “16:9”, “9:16”, and “1:1” in FIG. 6 may be interpreted as the crop type in S502 or S503. For example, when the crop type of the crop 1 is “16:9” in S502, the ranges of the X coordinates 0 to 960 and the Y coordinates 0 to 540 are determined as the settable range of the marker.

FIG. 4A is the marker area position setting screen when the marker reference is the “entire video”. In the case of FIG. 4A, a marker area can be set anywhere in the entire video 400. In the case of FIG. 4A, the coordinates of the marker area are determined in a coordinate system in which the coordinates of the upper left corner of the entire video 400 are (0, 0), and the coordinates of the lower right corner of the entire video 400 are (1920, 1080).

FIG. 4B is the marker area position setting screen in the case where the marker reference is “16:9”, and the aspect ratio of the area of the crop 1 is 16:9. In the case of FIG. 4B, the marker area can be set only within the area of the crop 1 where the aspect ratio is equal to the marker reference. The same applies to the case where the marker reference is the “crop 1”. As described above, when the marker area is set in association with the crop area, the marker area can be set only within the crop area.

In FIG. 4B, the crop 1 frame 302 and the crop 1 number 303 are also displayed. This indicates that the marker area can be set only within the area of the crop 1. In the case of FIG. 4B, the coordinates of the marker area are determined in a coordinate system in which the coordinates of the upper left corner of the area of the crop 1 (the crop 1 frame 302) are (0,0), and the coordinates of the lower right corner of the area of the crop 1 (the crop 1 frame 302) are (960,540). Note that the method for indicating that the marker area can be set only within the area of the crop 1 is not particularly limited, and for example, as illustrated in FIG. 4C, a mask 408 that covers the outside of the area of the crop 1 may be displayed.

Even when the marker reference is “9:16” or “1:1”, similarly to the case where the marker reference is “16:9”, the marker area can be set only within the crop area having the aspect ratio equal to that of the marker reference. A plurality of crop areas having an aspect ratio equal to the marker reference may be set. In this case, the marker area may be set only on the inner side of each of the plurality of crop areas having the aspect ratio equal to that of the marker reference, or the marker area may be set only on the inner side of any one of the plurality of crop areas. When the marker reference is the “crop 2”, the marker area can be set limiting to the area of the crop 2.

Although the position setting of the marker 1 is described, the position setting of the marker 2 can be similarly performed. In addition, the size of the marker area can be similarly set. When the user selects the item for setting the marker area size from the menu screen, the system control unit 50 displays the marker area size setting screen (not illustrated) on the display unit 110. The user uses the marker area size setting screen to designate (input) the width and height of the marker area instead of the X coordinate and the Y coordinate of the marker area.

As described above, in the first embodiment, the marker area is set using the position coordinates relative to the image area (the area of the entire video image, or the crop area) with which the marker area is associated.

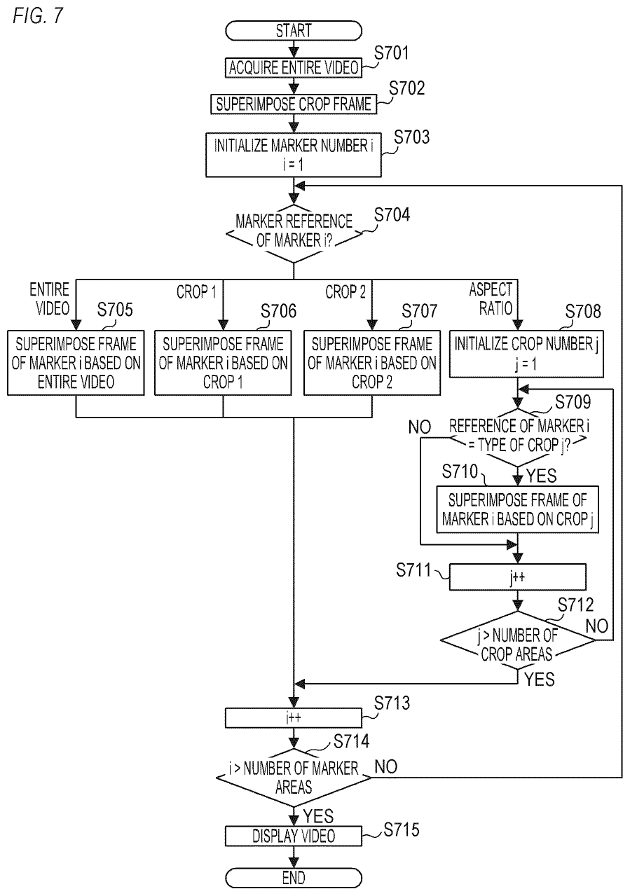

FIG. 7 is a flowchart illustrating a processing example of the camera 10 when the shooting screen is displayed after the setting of the crop area and the marker area. The process in FIG. 7 is implemented by the system control unit 50 loading a program stored in the nonvolatile memory 111 into the system memory 113 and executing the program. For example, when the user instructs display of the shooting screen (transition to the shooting mode or the like) after the setting of the crop area and the marker area, the system control unit 50 starts the process of FIG. 7. Then, the system control unit 50 repeats the process of FIG. 7 until the user instructs non-display of the shooting screen, such as turning off the power of the camera 10 or transitioning to another screen (another mode). The process of FIG. 7 is repeated at the display update rate (refresh rate) of the display unit 110. For example, when the refresh rate is 60 Hz, the process of FIG. 7 is repeated at a frequency of 60 times per second.

In S701, the system control unit 50 performs control to acquire the entire video captured by the image capturing unit 104.

In S702, the system control unit 50 performs control to superimpose a crop frame indicating a crop area on the entire video acquired in S701. In the first embodiment, it is assumed that the crop frame of the crop 1 and the crop frame of the crop 2 are superimposed on the entire video. Note that, in S702, the mode of the entire video may be changed so as to indicate the crop area, and a pixel value of the entire video may be changed instead of superimposing the crop frame.

In S703, the system control unit 50 initializes a marker number i to 1. The marker number i is a number indicating a marker area to be processed, and when the marker number i is 1, the marker 1 is selected as a processing target, and when the marker number i is 2, the marker 2 is selected as a processing target.

In S704, the system control unit 50 determines whether the marker reference of a marker i (marker area to be processed) is any one of the “entire video”, the “crop 1”, the “crop 2”, and an aspect ratio (“16:9”, “9:16”, or “1:1”). When the marker reference is the “entire video”, the process proceeds to S705. When the marker reference is the “crop 1”, the process proceeds to S706. When the marker reference is the “crop 2”, the process proceeds to S707. When the marker reference is the aspect ratio, the process proceeds to S708.

In S705, the system control unit 50 performs control to superimpose a marker frame indicating the area of the marker i on the entire video at coordinates based on the entire video. In the first embodiment, it is assumed that the marker frame is superimposed on the entire video according to the set coordinates (for example, center coordinates) and size of the marker i by using the coordinate system in which the coordinates of the upper left corner of the entire video are (0,0), and the coordinates of the lower right corner of the entire video are (1920,1080).

In S706, the system control unit 50 performs control to superimpose the marker frame of the marker i on the entire video at coordinates based on the crop 1. In the first embodiment, the marker frame is superimposed on the entire video according to the set coordinate and size of marker i using the coordinate system corresponding to the settable range (FIG. 6) corresponding to the crop type of crop 1. For example, when the crop type is “9:16”, a coordinate system in which the coordinates of the upper left corner of the area of the crop 1 are (0,0), and the coordinates of the lower right corner of the area of the crop 1 are (540,960) is used.

In S707, the system control unit 50 performs control to superimpose the marker frame of the marker i on the entire video at coordinates based on the crop 2. In the first embodiment, the marker frame is superimposed on the entire video according to the set coordinate and size of the marker i using the coordinate system corresponding to the settable range (FIG. 6) corresponding to the crop type of the crop 2.

In S708, the system control unit 50 initializes a crop number j to 1. The crop number j is a number indicating a crop area to be referred to, and when the crop number j is 1, the crop 1 is selected as the reference target, and when the crop number j is 2, the crop 2 is selected as the reference target.

In S709, the system control unit 50 determines whether the marker reference of the marker i matches the crop type of a crop j. When the marker reference of the marker i matches the crop type of the crop j, the process proceeds to S710, and when not, the process proceeds to S711. In the first embodiment, in the case of i=1 and j=1, when both the marker reference of the marker 1 and the crop type of the crop 1 are “16:9”, it is determined that the marker reference of the marker i and the crop type of the crop j match. Even when both the marker reference of the marker 1 and the crop type of the crop 1 are “9:16”, it is determined that the marker reference of the marker i and the crop type of the crop j match. Even when both the marker reference of the marker 1 and the crop type of the crop 1 are “1:1”, it is determined that the marker reference of the marker i and the crop type of the crop j match. In other cases, it is determined that the marker reference of the marker i does not match the crop type of the crop j.

In S710, the system control unit 50 performs control to superimpose the marker frame of the marker i on the entire video at coordinates based on the crop j. In the first embodiment, the marker frame is superimposed on the entire video according to the set coordinate and size of the marker i using the coordinate system corresponding to the settable range (FIG. 6) corresponding to the crop type of the crop j.

Note that, in S705 to S707, and S710, the mode of the entire video may be changed so as to indicate the marker area, and a pixel value of the entire video may be changed instead of superimposing the marker frame.

In S711, the system control unit 50 increments the crop number j by 1.

In S712, the system control unit 50 determines whether the crop number j is larger than the set number of crop areas (the number of crop areas). When the crop number j is larger than the number of crop areas, the process proceeds to S713. Otherwise, the process proceeds to S709.

In S713, the system control unit 50 increments the marker number i by 1.

In S714, the system control unit 50 determines whether the marker number i is larger than the set number of marker areas (the number of marker areas). When the marker number i is larger than the number of marker areas, the process proceeds to S715. Otherwise, the process proceeds to S704.

In S715, the system control unit 50 performs control to display the entire video on which the crop frame and the marker frame are superimposed on the display unit 110.

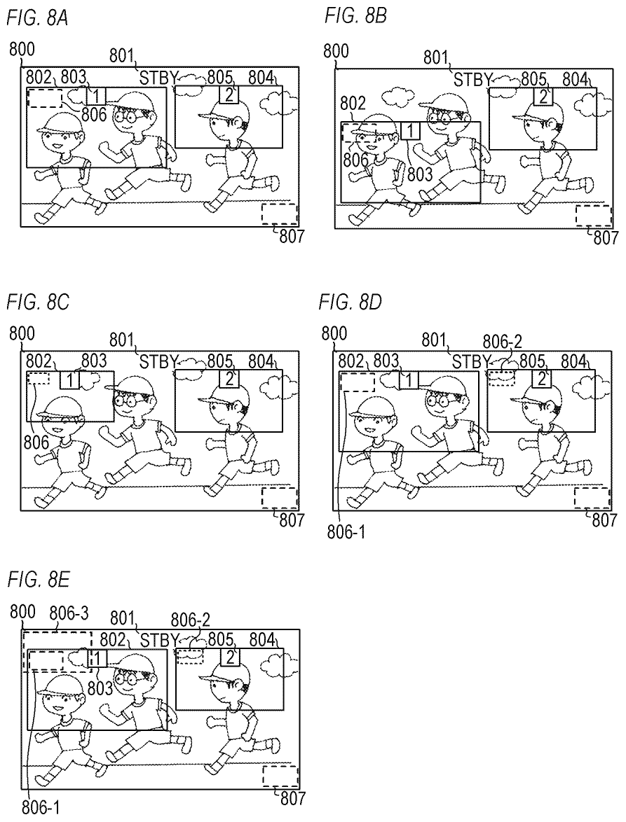

FIGS. 8A to 8E are schematic diagrams illustrating an example of a shooting screen. On the shooting screens of FIGS. 8A to 8E, a captured entire video 800 is displayed, and the plurality of OSDs are superimposed on the entire video 800.

On the shooting screen of FIG. 8A, the plurality of OSDs include a recording state 801, a crop 1 frame 802, a crop 1 number 803, a crop 2 frame 804, a crop 2 number 805, a marker 1 frame 806, and a marker 2 frame 807. In FIG. 8A, it is assumed that both the crop type of the crop 1 and the crop type of the crop 2 are “16:9”. In addition, it is assumed that the marker reference of the marker 1 is the “crop 1” and the marker reference of the marker 2 is the “entire video”. Therefore, the marker 1 frame 806 is superimposed on the entire video 800 in S706 in FIG. 7, and the marker 2 frame 807 is superimposed on the entire video 800 in S705. The marker 1 frame 806 is disposed at the upper left corner of the area of the crop 1 (the area surrounded by the crop 1 frame 802), and the marker 2 frame 807 is disposed at the lower right corner of the area of the entire video 800.

FIG. 8B illustrates the shooting screen after the crop 1 frame 802 is moved downward on the crop area setting screen from the state of FIG. 8A. Since the marker reference of the marker 1 is the “crop 1”, the marker 1 frame 806 also moves downward in accordance with the movement of the crop 1 frame 802. FIG. 8C is a shooting screen after the size of the crop 1 frame 802 is reduced on the crop area setting screen from the state of FIG. 8A. Since the marker reference of the marker 1 is the “crop 1”, the size of the marker 1 frame 806 is also reduced in accordance with the reduction in the size of the crop 1 frame 802.

As described above, in the first embodiment, when the marker area is associated with the crop area, if the setting of the crop area is changed, the display of the marker area is changed so as to maintain the relative position and size with respect to the crop area. As a result, it is possible to eliminate the trouble of the user who changes the setting of the marker area according to the setting change of the crop area, and it is possible to reduce the adjustment frequency of the marker area. Note that, in order that the user can freely determine the crop area and the marker area to some extent, even if the setting of the marker area is changed, the display of the crop area is not changed. Even when the setting of the crop area is changed, the display of the marker area not associated with the crop area is not changed.

FIG. 8D illustrates the shooting screen after the marker reference of the marker 1 is changed to “16:9” from the state of FIG. 8A. Since both the crop type of the crop 1 and the crop type of the crop 2 are “16:9”, a marker 1 frame 806-1 based on the crop 1 and a marker 1 frame 806-2 based on the crop 2 are superimposed on the entire video 800 in S710 of FIG. 7. The relative position and size of the marker 1 frame 806-1 with respect to the crop 1 frame 802 are the same as the relative position and size of the marker 1 frame 806-2 with respect to the crop 2 frame 804.

As described above, in the first embodiment, when a plurality of crop areas having an aspect ratio with which the marker area is associated are set, the entire video is displayed in a mode indicating a plurality of marker areas respectively corresponding to the plurality of crop areas as the marker area. At this time, the relative position and size of the marker area with respect to the crop area corresponding to the marker area are equal among the plurality of marker areas. As a result, the setting of the marker area can be shared between the crop areas having the same aspect ratio, and convenience is improved.

When the aspect ratio as the marker reference of the marker is equal to the aspect ratio of the entire video, a marker frame based on the entire video may be further superimposed on the entire video as the marker frame of the marker.

Similarly to FIG. 8D, FIG. 8E illustrates the shooting screen after the marker reference of the marker 1 is changed to “16:9” from the state of FIG. 8A. As described above, both the crop type of the crop 1 and the crop type of the crop 2 are “16:9”. Furthermore, it is assumed that the aspect ratio of the entire video 800 is also 16:9. In FIG. 8E, similarly to FIG. 8D, the marker 1 frame 806-1 based on the crop 1 and the marker 1 frame 806-2 based on the crop 2 are superimposed on the entire video 800 by the process in S710 of FIG. 7. Further, by the process of S710, the marker 1 frame 806-3 based on the entire video 800 is superimposed on the entire video 800.

Note that the entire video may be displayed in a mode in which the marker area associated with the crop area and the marker area not associated with the crop area can be identified. On the shooting screen of FIG. 8A, the marker 1 frame 806 of which the marker reference is the “crop 1” and the marker 2 frame 807 of which the marker reference is the “entire video” may be displayed in a distinguishable manner. The color of the marker 1 frame 806 and the color of the marker 2 frame 807 may be different. The brightness of the marker 1 frame 806 and the brightness of the marker 2 frame 807 may be different. The line type (such as a single line or a double line) of the marker 1 frame 806 and the line type of the marker 2 frame 807 may be different. The lighting/blinking pattern of the marker 1 frame 806 and the lighting/blinking pattern of the marker 2 frame 807 may be different. An icon corresponding to the marker reference “crop 1” may be displayed in association with the marker 1 frame 806, and an icon corresponding to the marker reference “entire video” may be displayed in association with the marker 2 frame 807. Similarly, the entire video may be displayed in a mode in which a marker area associated with the crop area and a marker area associated with another crop area can be identified.

Also on the crop area setting screen, the entire video may be displayed in a mode indicating the marker area (and the crop area). For example, when a crop area with which the marker area is not associated is set, the entire video may be displayed in a mode in which the crop area is indicated, but the marker area is not indicated. Then, when the crop area associated with the marker area is set, the entire video may be displayed in a mode indicating the crop area and the marker area. At this time, a marker area that is not associated with the crop area is not shown.

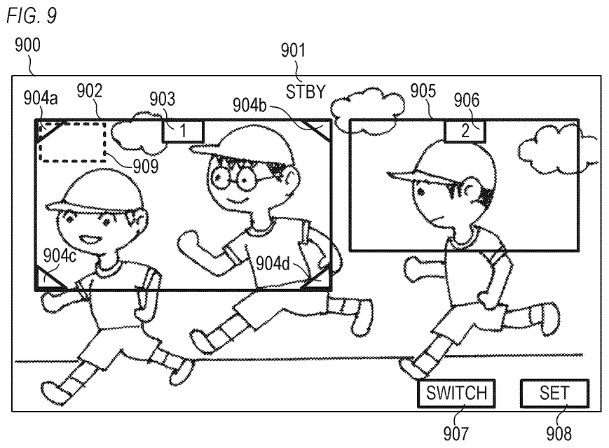

FIG. 9 is a schematic diagram illustrating an example of the crop area setting screen. On the crop area setting screen in FIG. 9, a captured entire video 900 is displayed, and a plurality of OSDs are superimposed on the entire video 900. Similarly to FIG. 3, the plurality of OSDs include a recording state 901, a crop 1 frame 902, a crop 1 number 903, crop frame size adjustment cursors 904a to 904d, a crop 2 frame 905, a crop 2 number 906, a switch button 907, and a SET button 908. Here, it is assumed that the marker 1 of the marker reference “crop 1” and the marker 2 of the marker reference “entire video” are set. Therefore, a marker 1 frame 909 of the marker reference “crop 1” is also superimposed on the entire video 900. The marker 2 frame of the marker reference “entire video” is not displayed. As a result, the user can adjust the crop area while referring to the marker area based on the crop area, and convenience is improved.

### Second Embodiment

A second embodiment of the present disclosure is described. Note that, in the following description, those the same as in the second embodiment (for example, the same configuration and process as in the first embodiment) are not described, and the difference from the second embodiment is described.

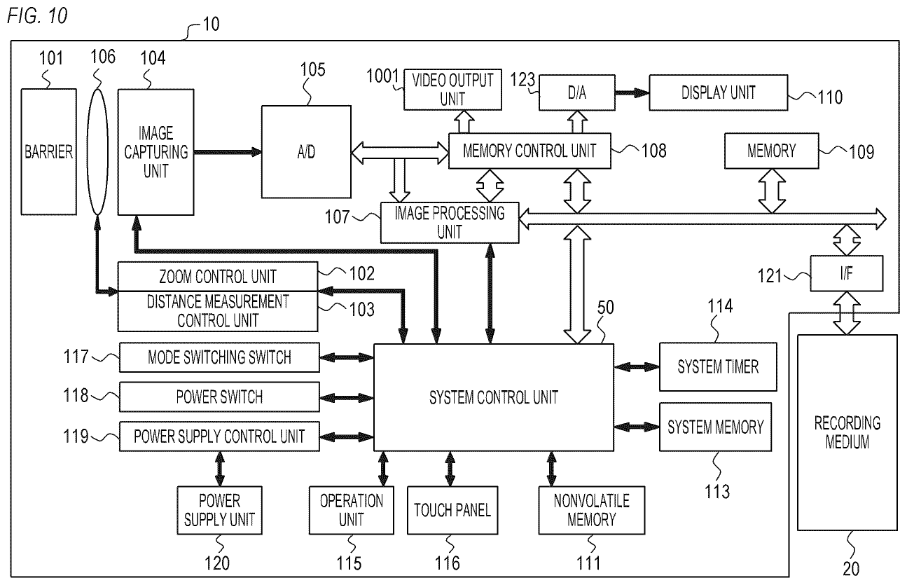

FIG. 10 is a block diagram illustrating a configuration of the digital video camera (camera) 10 according to the second embodiment. A video output unit 1001 reads the image data accumulated in the memory 109 via the memory control unit 108, converts the image data into a video signal, and outputs the converted video signal to the outside. In the second embodiment, the video output unit 1001 includes an HDMI terminal, converts the image data accumulated in the memory 109 into a signal of a video format corresponding to the HDMI terminal, and outputs the converted signal. The video output unit 1001 can extract (cut out and crop) the image data of the crop area from the image data of the entire video and output the image data. Note that the number of external output terminals included in the video output unit 1001 is not particularly limited. The video output unit 1001 may have an SDI terminal.

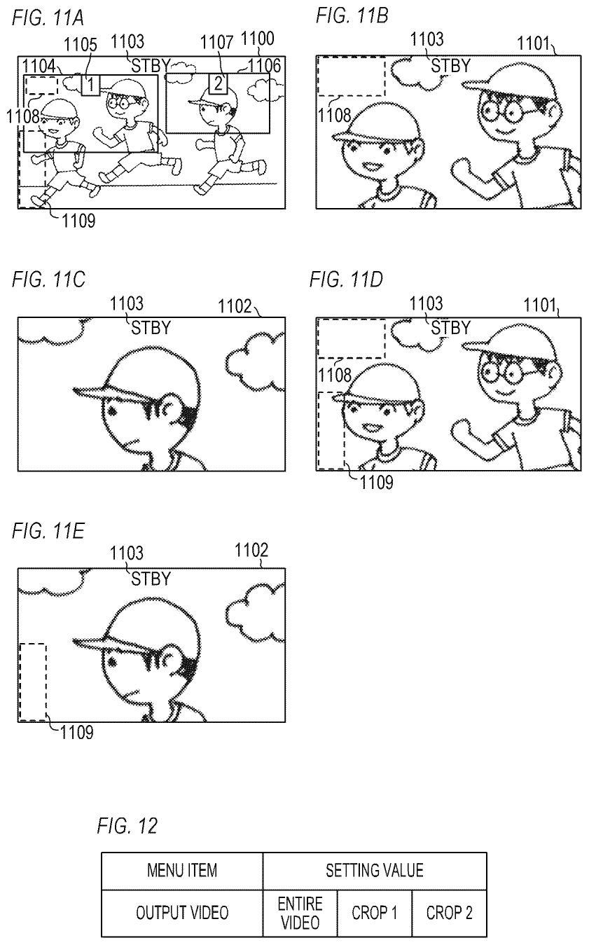

FIGS. 11A to 11E are schematic diagrams illustrating an example of an output video that is output from the video output unit 1001. FIG. 12 is a schematic diagram illustrating an example of menu items (setting items) for externally outputting a video and setting values thereof. As illustrated in FIG. 12, the user selects (designates) the “entire video”, the “crop 1”, or the “crop 2” as the output video (output video type).

FIG. 11A illustrates an output video when the output video type is the “entire video”. In FIG. 11A, the plurality of OSDs are superimposed on an entire video 1100. The plurality of OSDs include a recording state 1103, a crop 1 frame 1104, a crop 1 number 1105, a crop 2 frame 1106, a crop 2 number 1107, a marker 1 frame 1108, and a marker 2 frame 1109. In FIG. 11A, it is assumed that both the crop type of the crop 1 and the crop type of the crop 2 are “16:9”. In addition, it is assumed that the marker reference of the marker 1 is the “crop 1” and the marker reference of the marker 2 is the “entire video”.

FIG. 11B illustrates the output video after the output video type is changed from the state of FIG. 11A to the “crop 1”. In FIG. 11B, the recording state 1103 and the marker 1 frame 1108 of the marker reference “crop 1” (a portion included in the area of the crop 1) are superimposed on a crop 1 area video 1101 that is the video of the area of the crop 1. As illustrated in FIG. 11A, a part of the marker 2 frame 1109 is also included in the area of the crop 1, but the marker reference of the marker 2 is the “entire video”, and thus the marker 2 frame 1109 is not displayed in FIG. 11B.

FIG. 11C illustrates the output video after the output video type is changed from the state of FIG. 11A to the “crop 2”. In FIG. 11C, the recording state 1103 is superimposed on the crop 2 area video 1102 that is the video of the area of the crop 2. Even if at least a part of the marker 1 frame 1108 is included in the area of the crop 2, the marker reference of the marker 1 is the “crop 1”, so that the marker 1 frame 1108 is not superimposed on the crop 2 area video 1102. Similarly, even if at least a part of the marker 2 frame 1109 is included in the area of the crop 2, the marker reference of the marker 2 is the “entire video”, so that the marker 2 frame 1109 is not superimposed on the crop 2 area video 1102.

FIG. 11D illustrates the output video after the marker reference of the marker 2 is changed from the state in FIG. 11B to “16:9”. As described above, both the crop type of the crop 1 and the crop type of the crop 2 are “16:9”. Therefore, by changing the marker reference of the marker 2 to “16:9”, a marker 2 frame 1109-1 based on the crop 1 and a marker 2 frame 1109-2 based on the crop 2 (not illustrated in FIG. 11D) are set as the marker 2 frame 1109. Similarly to FIG. 11B, in FIG. 11D, the recording state 1103 and the marker 1 frame 1108 of the marker reference “crop 1” (a portion included in the area of the crop 1) are superimposed on the crop 1 area video 1101. Further, the marker 2 frame 1109-1 based on the crop 1 (a portion included in the area of the crop 1) is also superimposed on the crop 1 area video 1101.

FIG. 11E illustrates the output video after the output video type is changed from the state of FIG. 11D to the “crop 2”. Similarly to FIG. 11C, in FIG. 11E, the recording state 1103 is superimposed on the crop 2 area video 1102. Further, the marker 2 frame 1109-2 based on the crop 2 (a portion included in the area of the crop 2) is also superimposed on the crop 2 area video 1102.

As described above, when at least a part of the marker area is included in the crop area, if the marker area is associated with the crop area, the video of the crop area is output in a mode indicating the marker area (the portion included in the crop area). When the marker area is not associated with the crop area, the video of the crop area is output in a mode in which the marker area is not indicated.

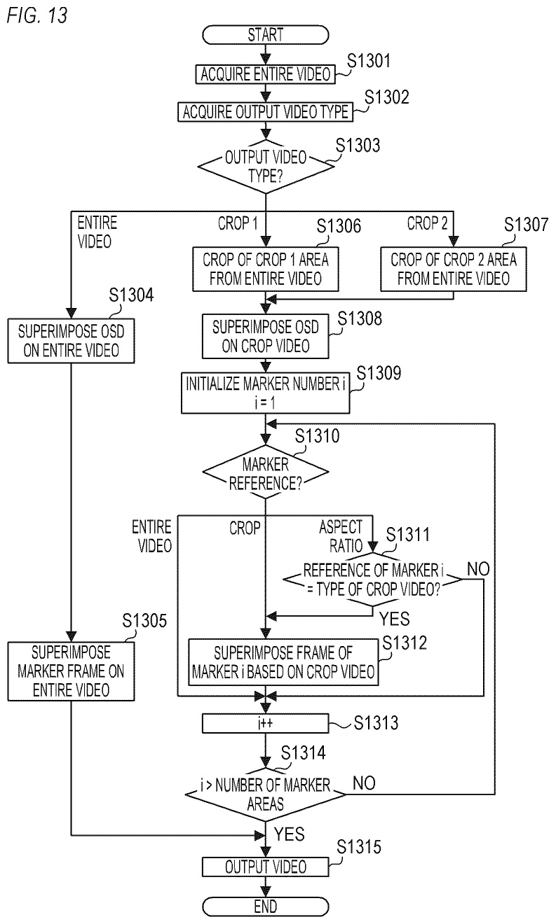

FIG. 13 is a flowchart illustrating a processing example of the camera 10 when the output video is output after the setting of the crop area and the marker area. The process in FIG. 13 is implemented by the system control unit 50 loading a program stored in the nonvolatile memory 111 into the system memory 113 and executing the program. For example, after setting of the crop area and the marker area, when the user instructs external output of the video (transition to the shooting mode or the like), the system control unit 50 starts the process of FIG. 13. Then, the system control unit 50 repeats the process of FIG. 13, until the user instructs to stop the external output of the video, such as turning off the power of the camera 10 or transitioning to another mode. The processing of FIG. 13 is repeated at the frame rate of the output video. For example, when the frame rate is 60 Hz, the process of FIG. 13 is repeated at a frequency of 60 times per second.

In S1301, the system control unit 50 performs control to acquire the entire video captured by the image capturing unit 104.

In S1302, the system control unit 50 acquires information of the set output video type.

In S1303, the system control unit 50 determines whether the output video type is the “entire video”, the “crop 1”, or the “crop 2”. The process proceeds to S1304 when the output video type is the “entire video”, the process proceeds to S1306 when the output video type is the “crop 1”, and the process proceeds to S1307 when the output video type is the “crop 2”.

In S1304, the system control unit 50 performs control to superimpose an OSD other than the marker frame on the entire video. For example, as illustrated in FIG. 11A, the recording state 1103, the crop 1 frame 1104, the crop 1 number 1105, the crop 2 frame 1106, and the crop 2 number 1107 are superimposed on the entire video 1100.

In S1305, the system control unit 50 performs control to superimpose all the marker frames on the entire video. For example, as illustrated in FIG. 11A, the marker 1 frame 1108 and the marker 2 frame 1109 are superimposed on the entire video 1100.

In S1306, the system control unit 50 performs control to crop (extract, cut out) the area of the crop 1 from the entire video. For example, the crop 1 area video 1101 illustrated in FIGS. 11B and 11D is cropped.

In S1307, the system control unit 50 performs control to crop (extract, cut out) the area of the crop 2 from the entire video. For example, the crop 2 area video 1102 illustrated in FIGS. 11C and 11E is cropped.

In S1308, the system control unit 50 performs control to superimpose a predetermined OSD on the cropped video. For example, as illustrated in FIGS. 11B to 11E, the recording state 1103 is superimposed. Note that a crop frame or a crop number corresponding to the cropped area may be superimposed, or when at least a part of another crop area is included in the cropped area, a crop frame or a crop number of the other crop area may be superimposed.

In S1309, the system control unit 50 initializes the marker number i to 1. As described in the first embodiment, the marker number i is a number indicating a marker area to be processed, and when the marker number i is 1, the marker 1 is selected as a processing target, and when the marker number i is 2, the marker 2 is selected as a processing target.

In S1310, the system control unit 50 determines whether the marker reference of the marker i (marker area to be processed) is any one of the “entire video”, the crop (the “crop 1” or the “crop 2”), and the aspect ratio (“16:9”, “9:16”, or “1:1”). When the marker reference is the “entire video”, the process proceeds to S1313, when the marker reference is the crop, the process proceeds to S1312, and when the marker reference is the aspect ratio, the process proceeds to S1311.

In S1311, the system control unit 50 determines whether the marker reference of the marker i matches the crop type of the output video. When the marker reference of the marker i matches the crop type of the output video, the process proceeds to S1312, and when not, the process proceeds to S1313. For example, as illustrated in FIG. 11D, when the output video type is the “crop 1”, the crop type of the crop 1 is “16:9”, and the marker reference of the marker 2 is “16:9”, it is determined that the marker reference of the marker 2 matches the crop type of the output video.

In S1312, the system control unit 50 performs control to superimpose the marker i based on the crop area of the output video on the output video. For example, the marker 1 frame 1108 is superimposed as illustrated in FIG. 11B, the marker 1 frame 1108 and the marker 2 frame 1109 are superimposed as illustrated in FIG. 11D, or the marker 2 frame 1109 is superimposed as illustrated in FIG. 11E.

In S1313, the system control unit 50 increments the marker number i by 1.

In S1314, the system control unit 50 determines whether the marker number i is larger than the set number of marker areas (the number of marker areas). When the marker number i is larger than the number of marker areas, the process proceeds to S1315. Otherwise, the process proceeds to S1310.

In S1315, the system control unit 50 performs control to output the output video from the video output unit 1001.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present disclosure are also included in the present disclosure. The present disclosure also includes other configurations obtained by suitably combining various features of the embodiment.

Furthermore, in the above-described embodiment, a case where the present disclosure is applied to a digital video camera that is a type of image capturing apparatus is described as an example, but the present disclosure is not limited to this example and can be applied to any electronic device capable of performing image display control. For example, the present disclosure can be applied to a personal computer, a PDA, a mobile phone terminal, a portable image viewer, a printer apparatus, a digital photo frame, a music player, a game machine, an electronic book reader, and the like. Also, the present disclosure can be applied to a video player, a display device (including a projection device), a tablet terminal, a smartphone, an AI speaker, a home electric appliance, an in-vehicle apparatus, and the like.

Also, the present disclosure can be applied not only to a main device of the image capturing apparatus but also to a control device that communicates with an image capturing apparatus (including a network camera) via wired or wireless communication to remotely control the image capturing apparatus. Examples of an apparatus that remotely controls the image capturing apparatus include devices such as a smartphone, a tablet PC, and a desktop PC. The image capturing apparatus can be controlled remotely by notifying the image capturing apparatus of a command from the control device side that causes the image capturing apparatus to perform various operations and settings based on an operation performed on the control device side or a process performed on the control device side. A live view image shot by the image capturing apparatus may be received via wired or wireless communication and may be displayed on the control device side.

According to the present disclosure, it is possible to reduce the adjustment frequency of the marker frame (the area on which graphics are superimposed).

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-220488, filed Dec. 17, 2024, which is hereby incorporated by reference herein in its entirety.

What is claimed is:

1. An electronic device comprising:
a processor; and
a memory storing a program which, when executed by the processor, causes the electronic device to
execute an acquisition process of acquiring an image,
execute a first setting process of setting a crop area that is a part of an area of the image and is an area extracted from the image,
execute a second setting process of setting a graphic area that is a part of an area of the image and is an area on which a graphic is to be superimposed, and
execute a control process of performing control to display the image in a mode indicating the crop area and the graphic area,
wherein, in the second setting process, the graphic area is settable in association with the crop area, and
in a case where the graphic area is associated with the crop area, in the control process, if a setting of the crop area is changed, a display of the graphic area is changed so that a relative position and a relative size of the graphic area with respect to the crop area are maintained, but even if a setting of the graphic area is changed, a display of the crop area is not changed.

2. The electronic device according to claim 1,
wherein, in a case where the graphic area is set in association with the crop area, in the second setting process, the graphic area is settable only within the crop area.

3. The electronic device according to claim 2,
wherein, in a case where the graphic area is set in association with the crop area, in the control process, control is performed to display that the graphic area is settable only within the crop area.

4. The electronic device according to claim 1,
wherein, in a case where the graphic area is set in association with the crop area, in the second setting process, the graphic area is set using position coordinates relative to the crop area.

5. The electronic device according to claim 1,
wherein, in the second setting process, a plurality of graphic areas are settable,
in a case where the setting of the crop area is changed, in the control process, a display of a graphic area associated with the crop area is changed so that a relative position and a relative size of the graphic area with respect to the crop area are maintained, but a display of a graphic area not associated with the crop area is not changed.

6. The electronic device according to claim 5,
wherein, in the control process, control is performed to display the image in a mode in which the graphic area associated with the crop area and the graphic area not associated with the crop area are able to be identified.

7. The electronic device according to claim 1,
wherein, in the second setting process, the graphic area is settable in association with an aspect ratio, and
a case where the graphic area is associated with the crop area includes a case where an aspect ratio with which the graphic area is associated is equal to an aspect ratio of the crop area.

8. The electronic device according to claim 7,
wherein in the first setting process, a plurality of crop areas are settable,
in a case where a plurality of crop areas having an aspect ratio with which the graphic area is associated are set, in the control process, control is performed to display the image in a mode indicating, as the graphic area, a plurality of graphic areas respectively corresponding to the plurality of crop areas, and
between the plurality of graphic areas, a relative position and a relative size of the graphic area with respect to the crop area corresponding to the graphic area are equal.

9. The electronic device according to claim 1,
wherein in the control process, in a case where the crop area with which the graphic area is not associated is set, control is performed to display the image in a mode indicating the crop area, and in a case where the crop area with which the graphic area is associated is set, control is performed to display the image in a mode indicating the crop area and the graphic area.

10. The electronic device according to claim 1,
when the program is executed by the processor, the program further causes the electronic device to execute an output process of outputting the image of the crop area,
in a case where at least a part of the graphic area is included in the crop area, in the output process, if the graphic area is associated with the crop area, the image of the crop area is output in a mode indicating the at least a part of the graphic area included in the crop area, but, if the graphic area is not associated with the crop area, the image of the crop area is output in a mode not indicating the graphic area.

11. A control method of an electronic device, comprising:
acquiring an image;
setting a crop area that is a part of an area of the image and is an area extracted from the image;
setting a graphic area that is a part of an area of the image and is an area on which a graphic is to be superimposed; and
performing control to display the image in a mode indicating the crop area and the graphic area,
wherein, the graphic area is settable in association with the crop area, and
in a case where the graphic area is associated with the crop area, if a setting of the crop area is changed, a display of the graphic area is changed so that a relative position and a relative size of the graphic area with respect to the crop area are maintained, but even if a setting of the graphic area is changed, a display of the crop area is not changed.

12. A non-transitory computer readable medium that stores a program, wherein the program causes a computer to execute a control method of an electronic device, the control method comprising:
acquiring an image;
setting a crop area that is a part of an area of the image and is an area extracted from the image;
setting a graphic area that is a part of an area of the image and is an area on which a graphic is to be superimposed; and
performing control to display the image in a mode indicating the crop area and the graphic area,
wherein, the graphic area is settable in association with the crop area, and
in a case where the graphic area is associated with the crop area, if a setting of the crop area is changed, a display of the graphic area is changed so that a relative position and a relative size of the graphic area with respect to the crop area are maintained, but even if a setting of the graphic area is changed, a display of the crop area is not changed.
